(19) United States
(12) Patent Application Publication
(10) Pub. No.: US 2006/0104212 A1
(43) Pub. Date: May 18, 2006

(54) Method of dynamically determining optimum size of buffer

(76) Inventor: Mao-Hsiung Lee, Jhubei City (TW)

Correspondence Address: J C PATENTS, INC., 4 VENTURE, SUITE 250, IRVINE, CA, 92618, US

(21) Appl. No.: 10/987,166

(22) Filed: Nov. 12, 2004

(51) Int. Cl. H04J 3/14; H04J 1/16; H04L 1/00; H04L 12/26; H04L 12/413

(52) U.S. Cl. 370/252

(57) ABSTRACT

A method of dynamically determining an optimum size of buffer suitable for media access controller (MAC) to access network is provided. First, a test packet is provided. Next, the test packet is transferred between the MAC and the buffer to obtain a transfer rate. Finally, an optimum size of the buffer is determined according to the transfer rate.

### BACKGROUND OF THE INVENTION

1.Field of the Invention

The present invention relates to a method of allocating memory, and more particularly, to a method of dynamically determining an optimum size of buffer.

2.Description of the Related Art

Since it is common in the computer communication that the timing of the network for sending/receiving data is different from the timing of the computer system, it is required to temporarily store the transferred data in a buffer. Usually, a fixed size of memory is allocated in the system memory, as a buffer, which is required for network to send/receive data. In other words, the buffer size (usually, it is a fixed size) is manually configured based on the speed of the commonly used CPU and the media access controller (MAC).

However, since the user environments are not the same (e.g. it may offer a better or worse system transmission performance), such technique of pre-determination of a fixed size of memory cannot assure communication quality, which may deteriorate the entire network efficiency. For example, if the predetermined buffer size is too large, the memory is wasted. On the other hand, if the predetermined buffer size is too small, there is a risk of losing data and adversely affect the data retransmission, which also deteriorates the transmission performance.

### SUMMARY OF THE INVENTION

Accordingly, the present invention is directed to a method of dynamically determining an optimum size of buffer to dynamically determine an allocated buffer size.

According to an embodiment of the present invention, the method of dynamically determining an optimum size of the buffer is suitable for a media access controller (MAC) to access network. First, a test packet is provided. Next, the test packet is transferred between the MAC and the buffer to obtain a transfer rate. Finally, an optimum size of the buffer is determined according to the transfer rate.

According to an embodiment of the present invention, the step of providing a test packet comprises generating the test packet and storing the test packet in the buffer.

According to an embodiment of the present invention, the step of transferring the test packet between the MAC and the buffer to obtain a transfer rate comprises transmitting the test packet from the buffer to the MAC, sending back the test packet to the buffer from the MAC and obtaining the transfer rate according to the time required for sending/receiving the test packet by the buffer.

According to an embodiment of the present invention, the step of determining optimum size of the buffer according to the transfer rate comprises providing a standard size, a high level size and a low level size of the buffer, and calculating a standard size, a high level size, and a low level size so as to obtain an optimum size of the buffer corresponding to the transfer rate. Wherein, the step of calculating it's a standard size, a high level size and a low level size of the buffer is performed by using an interpolation method or an extrapolation method.

According to an embodiment of the present invention, the step of determining an optimum size of the buffer according to the transfer rate comprises providing a lookup table and obtaining the optimum size of buffer by enquiring the lookup table according to the transfer rate.

Since the transferred rate is obtained by transferring a test packet between the MAC and the buffer, it is possible to determine the optimum size of buffer according to the transfer rate. Therefore, it the possibility of obtaining an allocated size of buffer from being too big or too small for a data transmission can be effectively reduced, so that a better communication quality can be assured, and the performance of the entire network can be effectively promoted.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 schematically shows a diagram for describing the memory allocated by the system as a network packet buffer.

FIG. 2 schematically shows a flow chart illustrating a method of dynamically determining an optimum size according to an embodiment of the present invention.

FIG. 3 schematically shows a diagram illustrating a relationship between the CPU speed and the required buffer size.

FIG. 4 schematically shows a flow chart illustrating a method of dynamically determining an optimum size according to another embodiment of the present invention.

### DESCRIPTION OF EMBODIMENTS

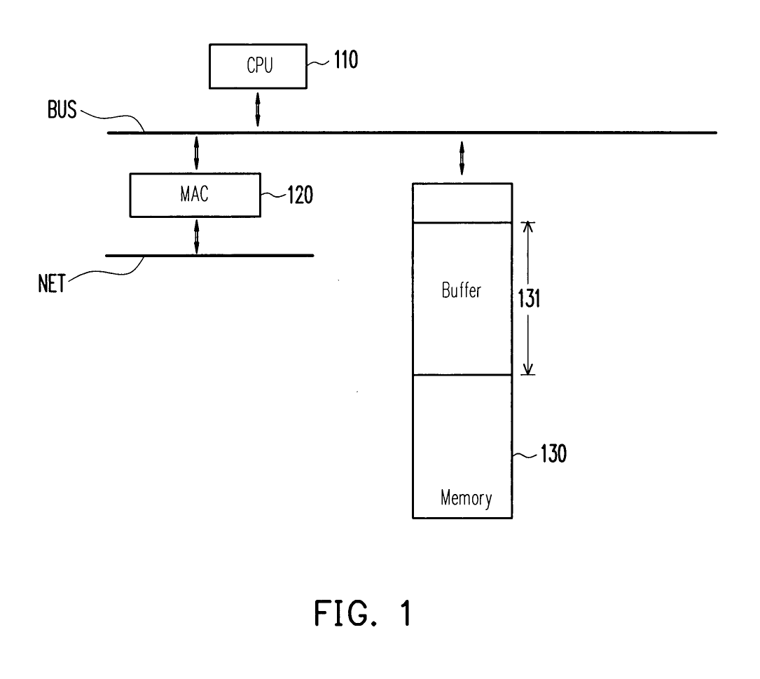

It is required to allocate a specific size of memory as a buffer for sending/receiving packet in the general network. FIG. 1 schematically shows a diagram for describing the memory allocated by the system as a network packet buffer. Referring to FIG. 1, with the control of a central processing unit (CPU) 110, the system can access an Ethernet (NET) by using a media access controller (MAC) 120. Here, the MAC 120 is for example embodied by a FTMAC 1000 IC (Integrated Circuit). However, the timing for sending/receiving packet by a network NET is usually different from the timing of the computer system, thus it is required to temperately store the packet sent or received by the MAC 120 via a bus BUS in a memory 130. Generally speaking, the Ethernet system will allocate a specific size of the memory 130 as a buffer for sending/receiving packet during its initialization, and this is refereed to as a buffer 131.

The size of the buffer 131 is dependent on the speed of the CPU 110 and MAC 120 as well as the size of the system memory 130. If the size of the allocated buffer 131 is too large, the utilization of the whole memory 130 is low accordingly, thus it cannot be fully utilized in a case when other application requires using the memory 130. On the other hand, if the size of the allocated buffer 131 is too small, when a great amount of data packet is transmitted to the MAC 120 via the Ethernet NET, it is quite common that the data packet may be lost due to the busy status of the bus BUS. Furthermore, if the sliding window protocol is applied by the network, when the data packet is lost due to the busy status bus BUS, all packets within the whole window rather than a single packet are required to be retransmitted, in such a case, the performance of the MAC 120 is significantly deteriorated.

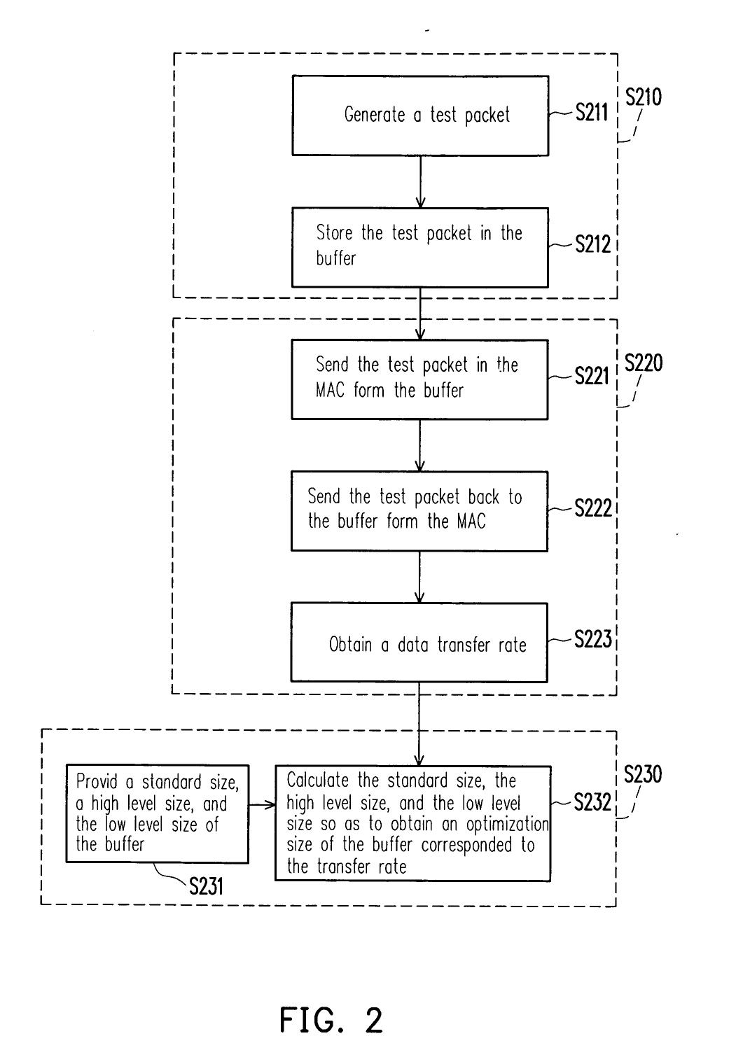

Therefore, according to an embodiment of the present invention, the MAC 120 is adapted to access the network NET for dynamically determining an optimum size of the buffer 131 for using by the MAC 120. FIG. 2 schematically shows a flow chart illustrating a method for dynamically determining an optimum size according to a an embodiment of the present invention. Referring to both FIGS. 1 and 2, first, a test packet is provided (step S210). Next, the test packet is transmitted between the MAC 120 and the buffer 131 in order to obtain a transfer rate (step S220). Finally, the size of the buffer 131 is determined according to the transfer rate (step S230).

The step S210 mentioned above is implemented as follows. First, at step S211, a “loopback mode” is, for example, configured in the Ethernet when it is normally initialized to automatically generate a test packet. Then, at step S212, the test packet is stored in the buffer 131.

The step S220 mentioned above is implemented as follows. First, at step S221, the test packet is transmitted from the buffer 131 to the MAC 120 via the bus BUS by using the “loopback mode”. Then, at step S222, the test packet is sent back to the buffer 131 from the MAC 120. Therefore, the real packet transfer rate of the CPU 110 can be obtained by calculating the time for sending/receiving packet by the buffer 131.

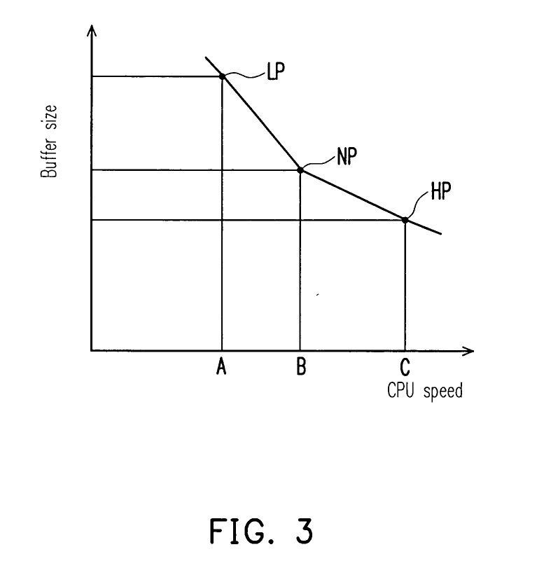

The step S230 mentioned above is implemented as follows. First, at step S231, a standard size, a high level size and a low level size of the buffer 131 are provided, wherein the standard size, the high level size and the low level size are described as follows. FIG. 3 schematically shows a diagram illustrating a relationship between the CPU speed and the required buffer size. Referring to both FIGS. 1 and 3, where X-axis indicates the CPU speed for transmitting packet, and Y-axis indicates the required buffer size. The size of the buffer 131 is usually dependent on the speed of the CPU 110 for transmitting packet. The high level of the computer system (i.e. the CPU provides faster speed to transmit packet) requires smaller buffer size. On the other hand, the low level of the computer system (i.e. the CPU provides lower speed to transmit packet) requires larger buffer size. The standard size (i.e. the NP point shown in FIG. 3) is the required optimum size of the buffer, which is obtained by physically testing the currently common-used CPU. The low level size (i.e. the LP point shown in FIG. 3) is the required optimum size of the buffer, which is obtained by physically testing the low level CPU. Similarly, the high level size (i.e. the HP point shown in FIG. 3) is the required optimum size of the buffer, which is obtained by physically testing the high level CPU.

At step S232, if the current transfer rate is between A and B shown in FIG. 3, the size of the buffer corresponding to the current transfer rate is obtained by calculating the standard size and the low level size with an interpolation method. If the current transfer rate is between B and C shown in FIG. 3, the size of the buffer corresponding to the current transfer rate is obtained by calculating the standard size and the high level size with an interpolation method. If the current transfer rate is greater than C or less than A shown in FIG. 3, the size of the buffer corresponding to the current transfer rate is obtained by using an extrapolation method. Therefore, the optimum size of the buffer 131 can be determined.

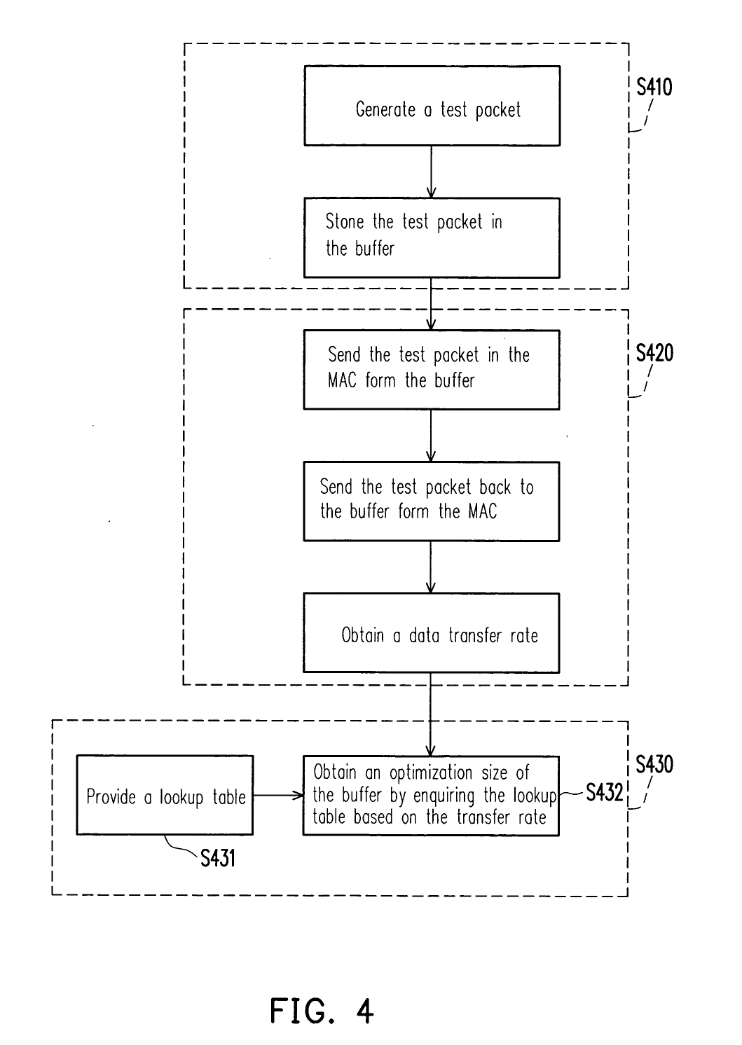

FIG. 4 schematically shows a flow chart illustrating a method of dynamically determining an optimum size according to another embodiment of the present invention. First, a test packet is provided (step S410). Next, the test packet is transmitted between the MAC 120 and the buffer 131 in order to obtain a transfer rate (step S420). Finally, the size of the buffer 131 is determined according to the transfer rate (step S430).

The steps S410 and S420 mentioned above are similar to the steps S210 and S220 described in the previous embodiment with reference to FIG. 2, thus the detail description thereof is is not repeated. The step S430 is implemented as follows. First, at step S431, a lookup table is provided, wherein the lookup table is created by testing the optimum size of buffer with respect to various transfer rates in advance. Next, at step S432, the optimum size of buffer 131 can be obtained by enquiring the lookup table according to the transfer rate.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A method of dynamically determining an optimum size of a buffer suitable for a media access controller (MAC) to access a network, comprising:
providing a test packet;
obtaining a transfer rate by transmitting the test packet between the MAC and the buffer; and
determining the size of the buffer according to the transfer rate.

2. The method of dynamically determining an optimum size of a buffer of claim 1, wherein the step of providing a test packet comprises:
generating the test packet; and
storing the test packet in the buffer.

3. The method of claim 1, wherein the step of obtaining a transfer rate by transmitting the test packet between the MAC and the buffer comprises:
transmitting the test packet from the buffer to the MAC;
sending back the test packet to the buffer from the MAC; and
obtaining the transfer rate by calculating a time for buffer to send and receive the test packet.

4. The method of claim 1, wherein the step of determining the size of the buffer according to the transfer rate comprises:
providing a standard size, a high level size, and a low level size of the buffer; and
calculating the standard size, the high level size, and the low level size, so as to obtain the size of the buffer corresponding to the transfer rate.

5. The method of claim 4, wherein the step of calculating the standard size, the high level size, and the low level size is performed by using an interpolation method.

6. The method of claim 4, wherein the step of calculating the size of the buffer is performed by using an extrapolation method.

7. The method of dynamically determining an optimum size of a buffer of claim 1, wherein the step of determining the size of the buffer according to the transfer rate comprises:
providing a lookup table; and
obtaining the size of the buffer by enquiring the lookup table according to the transfer rate.

8. The method of claim 1, wherein the buffer is a system memory, and the step of determining the size of the buffer according to the transfer rate determines a ratio of the system memory.
